(19) United States
(12) Patent Application Publication
(10) Pub. No.: US 2002/0107912 A1
(43) Pub. Date: Aug. 8, 2002

(54) Motor vehicle drive recorder system which records motor vehicle data proximate an event declared by a motor veicle occupant

(75) Inventor: Richard J. Chutorash, Rochester Hills, MI (US)

Correspondence Address: James N. Kallis, Brooks & Kushman P.C., Twenty-Second Floor, 1000 Town Center, Southfield, MI, 48075, US

(73) Assignee: LEAR CORPORATION, Southfield, MI (US)

(21) Appl. No.: 09/779,717

(22) Filed: Feb. 8, 2001

(51) Int. Cl. G06F 15/16; G06F 9/46

(52) U.S. Cl. 709/203; 709/318

(57) ABSTRACT

A motor vehicle drive recorder system and system for recording motor vehicle data in response to an event declared by an occupant of a motor vehicle includes a sensor for generating sensor signals indicative of motor vehicle data as a function of time. A switch generates an event signal indicative of a declared event in response to an occupant of the motor vehicle actuating the switch. A memory device stores the sensor signals as a function of time. An output device outputs the sensor signals stored in the memory device. A processor is operable with the sensor, the switch, the memory device, and the output device to write sensor signals into the memory device, to mark at least one sensor signal written to the memory device as corresponding in time to the declared event in response to the switch generating an event signal, and to transfer from the memory device to the output device the sensor signals stored in the memory device proximate in time to the declared event.

The present invention relates generally to drive recorders for motor vehicles and, more particularly, to a motor vehicle drive recorder system which records motor vehicle data proximate an event declared by an occupant of the motor vehicle.

### BACKGROUND ART

Drive recorders are used in motor vehicles for storing information relating to the operating conditions of the motor vehicle. Sensors in the motor vehicle such as acceleration sensors monitor various operating conditions of the motor vehicle. The sensors provide sensor signals indicative of the monitored information to the drive recorder for storage. In the event of an accident, such information may be later analyzed for accident reconstruction. Typical drive recorders continuously store motor vehicle data automatically. It is desired that the drive recorders have the ability to record information in response to an event declared by an occupant of the motor vehicle.

### SUMMARY OF THE INVENTION

Accordingly, it is an object of the present invention to provide a motor vehicle drive recorder system which records motor vehicle data proximate an event declared by an occupant of the motor vehicle.

It is another object of the present invention to provide a motor vehicle drive recorder system which records motor vehicle data including camera images proximate an event declared by an occupant of the motor vehicle.

It is a further object of the present invention to provide a motor vehicle drive recorder system which records motor vehicle data proximate an event such as irregular behavior of the motor vehicle, witnessing an accident involving other motor vehicles, driving past a landmark, etc., declared by an occupant of the motor vehicle.

In carrying out the above objects and other objects, the present invention provides a motor vehicle drive recorder system for recording motor vehicle data in response to an event declared by an occupant of a motor vehicle. The system includes a sensor for generating sensor signals indicative of motor vehicle data as a function of time. A switch generates an event signal indicative of a declared event in response to an occupant of the motor vehicle actuating the switch. A memory device stores the sensor signals as a function of time. An output device outputs the sensor signals stored in the memory device. A processor is operable with the sensor, the switch, the memory device, and the output device to write sensor signals into the memory device, to mark at least one sensor signal written to the memory device as corresponding in time to the declared event in response to the switch generating an event signal, and to transfer from the memory device to the output device the sensor signals stored in the memory device proximate in time to the declared event.

Further, in carrying out the above objects and other objects, the present invention provides a method for recording motor vehicle data in response to an event declared by an occupant of a motor vehicle. The method includes generating sensor signals indicative of motor vehicle data as a function of time and generating an event signal indicative of a declared event in response to an occupant of the motor vehicle actuating a switch. The sensor signals are written into a memory device for storing the sensor signals. At least one sensor signal written to the memory device is marked as corresponding in time to the declared event in response to the event signal being generated. The sensor signals stored in the memory device proximate in time to the declared event are then transferred from the memory device to an output device.

The above objects and other objects, features, and advantages of the present invention are readily apparent from the following detailed description of the best mode for carrying out the present invention when taken in connection with the accompanying drawings.

### BRIEF DESCRIPTION OF THE DRAWINGS

FIG. 1 illustrates a block diagram of the motor vehicle drive recorder system in accordance with the present invention; and

FIG. 2 illustrates a flowchart describing operation of the motor vehicle drive recorder system in accordance with the present invention.

### BEST MODES FOR CARRYING OUT THE INVENTION

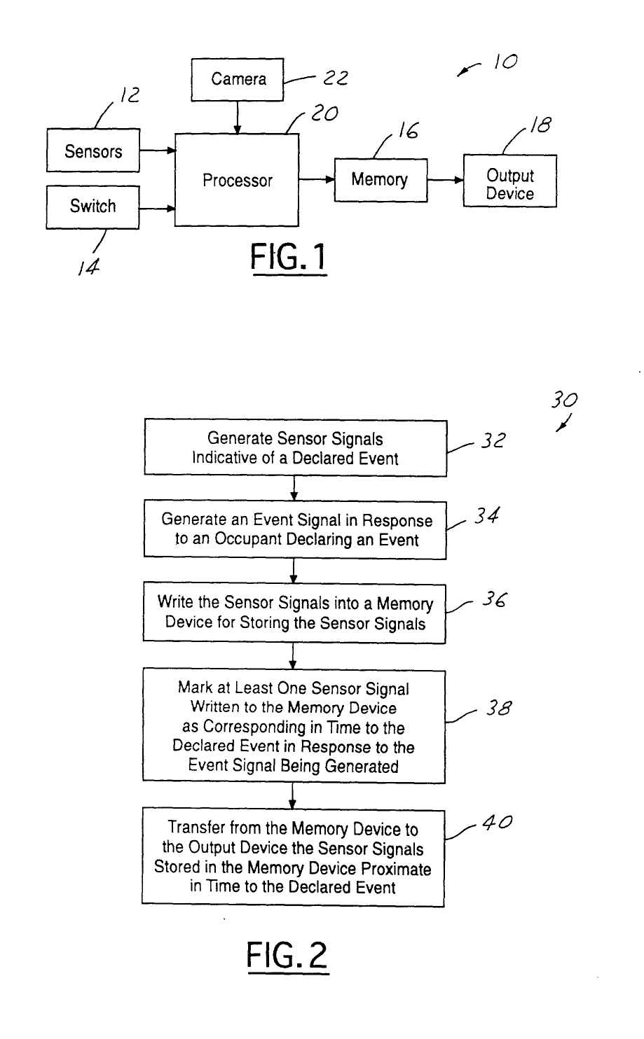

Referring now to FIG. 1, a motor vehicle drive recorder system 10 in accordance with the present invention is shown. Generally, system 10 records motor vehicle data in response to an event declared by an occupant of a motor vehicle. The recorded motor vehicle data may include data before, during, and after a declared event. System 10 includes at least one motor vehicle sensor 12 disposed within a motor vehicle for generating sensor signals indicative of a motor vehicle data as a function of time. A switch 14 generates an event signal indicative of a declared event in response to an occupant of the motor vehicle actuating the switch. A memory device 16 stores the sensor signals as a function of time. An output device 18 outputs the sensor signals stored in memory device 16. A processor 20 is operable with sensor 12, switch 14, memory device 16, and output device 18 to write the sensor signals into the memory device, to mark at least one sensor signal written to the memory device as corresponding in time to the declared event in response to the switch generating an event signal, and to transfer from the memory device to the output device the sensor signals stored in the memory device proximate in time to the declared event.

Sensor 12 may generally include various sensors for monitoring various motor vehicle data as a function of time. Such motor vehicle data includes motor vehicle acceleration, velocity, travel direction, inclination, absolute location, and location to other motor vehicles; conditions of motor vehicle systems such as brakes, tires, steering, engine, and lighting; and motor vehicle occupant conditions such as the number of motor vehicle occupants, the location of the motor vehicle occupants, identification of the operator of the motor vehicle, and voice data of the occupants. For example, sensor 12 may include an acceleration sensor for generating sensor signals indicative of acceleration of the motor vehicle as a function of time in the three directions of X-axis, Y-axis, and Z-axis in a rectangular coordinate system of a three-dimensional space. Sensor 12 is generally disposed within the motor vehicle and connected to a component of the motor vehicle for monitoring the conditions of the component during operation of the motor vehicle in order to generate a sensor signal indicative of the conditions of the component.

Sensor 12 may also include a video camera 22 for generating video signals of images of the environment proximate the motor vehicle. Such images may include images of the environment in front of the motor vehicle as seen by the operator of the motor vehicle while driving. Video camera 22 may be operable for generating video images in day time and night time conditions.

Switch 14 is disposed proximate to an occupant of the motor vehicle. For example, switch 14 may be a button on the dashboard of the motor vehicle. Switch 14 is operable to generate an event signal indicative of a declared event in response to an occupant of the motor vehicle manually actuating the switch. For instance, an occupant may declare an event in response to irregular behavior of the motor vehicle, witnessing an accident involving other motor vehicles, driving past a landmark, etc. In general, switch 14 enables a motor vehicle occupant to manually declare an event.

Memory device 16 is preferably non-volatile memory which stores the sensor signals as a function of time generated by sensor 12 and camera 22. Memory device 16 may be embodied in a removable medium such as tape, disk, or optical storage. Memory device 16 may also be embodied in RAM, flash memory, EEPROM, and other types of memory.

Output device 18 outputs the sensor signals stored in memory device 16. Output device 18 generally reads and transforms the sensor signals into a medium suitable for human analysis. Output device 18 may include portable permanent memory for storing the sensor signals stored in memory device. Output device 18 may be operable for analyzing the sensor signals to highlight specific sensor signals which are indicative of abnormal motor vehicle conditions. Output device 18 compares the stores sensor signals to ideal sensor signals to determine if the stored sensor signals are indicative of abnormal motor vehicle conditions.

Processor 20 is a microprocessor or the like. Generally, processor 20 receives the sensor signals generated by sensor 12 and the video sensor signals generated by camera 22. Processor 20 writes the sensor signals to memory device 16. Processor 20 is operable with switch 14 to mark an event declared by a motor vehicle occupant in response to the switch being actuated. Processor 20 marks the time at which the event was declared. Processor 20 controls memory device 16 to transfer the sensor signals stored in the memory device to output device 18 proximate in time to the declared event. Such sensor signals may include motor vehicle information a predetermined time period before, during, and a predetermined time period after a declared event.

Referring now to FIG. 2, a flowchart 30 describing operation of motor vehicle drive recorder system 10 in accordance with the present invention is shown. Flowchart 30 begins with generating sensor signals indicative of motor vehicle data as a function of time as shown in block 32. An event signal indicative of a declared event in response to an occupant of the motor vehicle actuating a switch is then generated as shown in block 34. The sensor signals are then written into a memory device for storing the sensor signals as shown in block 36. The sensor signals may be written into the memory device in response to the event signal being generated. At least one sensor signal written to the memory device is then marked as corresponding in time to the declared event in response to the event signal being generated as shown in block 38. The sensor signals stored in the memory device proximate in time to the declared event are then transferred from the memory device to the output device as shown in block 40. The sensor signals transferred from the memory device to the output device may include the sensor signals stored in the memory device before, during, and after the declared event.

Thus it is apparent that there has been provided, in accordance with the present invention, a motor vehicle drive recorder system for recording motor vehicle data proximate an event declared by an occupant of the motor vehicle that fully satisfies the objects, aims, and advantages set forth above. While the present invention has been described in conjunction with specific embodiments thereof, it is evident that many alternatives, modifications, and variations will be apparent to those skilled in the art in light of the foregoing description. Accordingly, it is intended to embrace all such alternatives.

What is claimed is:

1. A motor vehicle drive recorder system for recording motor vehicle data in response to an event declared by an occupant of a motor vehicle, the system comprising:
a sensor for generating sensor signals indicative of motor vehicle data as a function of time;
a switch for generating an event signal indicative of a declared event in response to an occupant of the motor vehicle actuating the switch;
a memory device for storing the sensor signals as a function of time;
an output device for outputting the sensor signals stored in the memory device; and
a processor operable with the sensor, the switch, the memory device, and the output device to write the sensor signals into the memory device, to mark at least one sensor signal written to the memory device as corresponding in time to the declared event in response to the switch generating an event signal, and to transfer from the memory device to the output device the sensor signals stored in the memory device proximate in time to the declared event.

2. The system of claim 1 wherein:
the processor is operable to write the sensor signals into the memory device in response to the switch generating an event signal.

3. The system of claim 1 wherein:
the sensor is disposed within the motor vehicle.

4. The system of claim 1 wherein:
the sensor includes an acceleration sensor for generating a sensor signal indicative of motor vehicle acceleration as a function of time.

5. The system of claim 1 wherein:
the sensor includes a video camera for generating a sensor signal indicative of video images of the environment surrounding the motor vehicle.

6. The system of claim 1 wherein:
the memory device is a non-volatile memory device.

7. The system of claim 1 wherein:
the processor is operable to transfer from the memory device to the output device the sensor signals stored in the memory device before, during, and after the declared event.

8. A method for recording motor vehicle data in response to an event declared by an occupant of a motor vehicle, the method comprising:
generating sensor signals indicative of motor vehicle data as a function of time;
generating an event signal indicative of a declared event in response to an occupant of the motor vehicle actuating a switch;
writing the sensor signals into a memory device for storing the sensor signals;
marking at least one sensor signal written to the memory device as corresponding in time to the declared event in response to the event signal being generated; and
transferring from the memory device to the output device the sensor signals stored in the memory device proximate in time to the declared event.

9. The method of claim 8 wherein:
writing the sensor signals into a memory device includes writing the sensor signals into the memory device in response to the event signal being generated.

10. The method of claim 8 wherein:
generating sensor signals includes generating a sensor signal indicative of motor vehicle acceleration as a function of time.

11. The method of claim 8 wherein:
generating sensor signals includes generating a sensor signal indicative of video images of the environment surrounding the motor vehicle.

12. The method of claim of claim 8 wherein:
transferring from the memory device to the output device the sensor signals stored in the memory device proximate in time to the declared event includes transferring the sensor signals stored in the memory device before, during, and after the declared event.

13. A method for recording motor vehicle data in response to an event declared by an occupant of a motor vehicle, the method comprising:
generating sensor signals indicative of motor vehicle data as a function of time;
generating an event signal indicative of a declared event in response to an occupant of the motor vehicle actuating a switch;
writing the sensor signals into a memory device for storing the sensor signals;
marking at least one sensor signal written to the memory device as corresponding in time to the declared event in response to the event signal being generated; and
transferring from the memory device to the output device the sensor signals stored in the memory device before, during, and after the declared event.
